(19) United States
(12) Patent Application Publication
(10) Pub. No.: US 2025/0214312 A1
(43) Pub. Date: Jul. 3, 2025

(54) PRODUCTION SYSTEM FOR PACKAGING ELEMENTS FOR AEROSOL-GENERATING ARTICLES WITH PACKAGING ELEMENT IDENTIFICATION

(71) Applicant: Philip Morris Products S.A., Neuchatel (CH)

(72) Inventors: Guido Norbert FREUND, Schönefeld (DE); Lars PUTTER, Muri bei Bern (CH)

(73) Assignee: Philip Morris Products S.A., Neuchatel (CH)

(21) Appl. No.: 18/853,218

(22) PCT Filed: Apr. 12, 2023
(86) PCT No.: PCT/EP2023/059498

§ 371 Date: Oct. 1, 2024

(30) Foreign Application Priority Data
Apr. 12, 2022 (EP) 22167757.8

(51) Int. Cl. B31B 50/00; B31B 50/16; B31B 50/88; B31B 105/00; G05B 19/418

(52) U.S. Cl. CPC B31B 50/006; B31B 50/16; B31B 50/88; G05B 19/41875; B31B 2105/00; G05B 2219/32368

(57) ABSTRACT

A production system for packaging elements for aerosol-generating articles is provided, a packaging element being formed by a region of a packaging material, the system including: a printing station to print onto each of the elements an identifier marking readable as packaging element identification information of the corresponding element; a quality assessment station to carry out a quality assessment of each element; a transport system to transport the elements along a production direction through the printing station and the quality assessment station; a data memory; a sorting station; and a controller to store in the memory a dataset for retrieving a result of the quality assessment based on the information of the particular element, the sorting station to read the identifier marking to obtain the information, and to retrieve the result of the quality assessment from the dataset based on the obtained information.

The present disclosure relates to quality control in production of packaging elements for consumer products, in particular for aerosol-generating articles.

There is a need for an improved way of carrying out quality control during production of packaging elements. There is a need for an improved way of integrating quality control into a production process for packaging elements.

According to an aspect of the present invention, there is provided a production system for packaging elements for aerosol-generating articles, wherein a packaging element is formed by a region of a packaging material. The production system comprises a printing station, a quality assessment station, a transport system, and a data memory. The printing station is configured to print onto each of the packaging elements an identifier marking that is readable as packaging element identification information of the corresponding packaging element. The quality assessment station is configured to carry out a quality assessment of each packaging element. The transport system is configured to transport the packaging elements along a production direction at least through the printing station and the quality assessment station. The production system comprises a controller. The controller is configured to store a dataset in the data memory. The dataset allows or enables retrieving a result of the quality assessment for a packaging element or any one of the packaging elements based on the packaging element identification information of the particular packaging element.

Since the identifier markings are readable as packaging element identification information of the corresponding packaging element, the packaging element may be identified based on the identifier marking. In particular, the packaging element may be identified based on the identifier marking during a production process of the packaging element. The packaging element may be identified based on the identifier marking even after completion of a production process.

The dataset, in combination with the identifier markings printed on the packaging elements, may allow attributing the results of the quality assessment to the individual packaging elements. For example, if the packaging elements are scrambled, or track of the packaging elements is lost, the result of the quality assessment for any particular packaging element may be retrieved based on the identifier marking printed on the packaging element and the stored dataset. Retrieval of the result of the quality assessment for a particular packaging element may be possible during a production process, or after the production process, or both during the production process and after the production process. Even if production of the packaging elements or treatment of the packaging elements is interrupted, it may still be possible to retrieve the result of the quality assessment of any one of the packaging elements based on the packaging element identification information of the particular packaging element. Thus, production or treatment of the packaging elements may be carried out in different stages at different locations, or at different times without the need to repeat quality assessment of the packaging elements. For example, the packaging elements may be stored for some time after the quality assessment and the result of the quality assessment may later be retrieved, when continuing working with or on the packaging elements.

The dataset may be used for documentation of a production process of the packaging elements or as documentation of the quality control of the packaging elements.

The dataset may be locally stored. The dataset may be stored so as to be remotely accessible. The dataset may be stored in a cloud system. The dataset may be electronically transmitted, in particular by wired communication of by wireless communication.

The packaging material may comprise paper or cardboard. The packaging material may comprise coated paper or coated cardboard.

The packaging element may be a designated region in the packaging material. The packaging material may comprise one or more packaging elements. The designated region may be integral with at least one portion of the packaging material at least partially surrounding the designated region. The packaging element may be a blank cut from the packaging material. The packaging element may be a blank of packaging material. The packaging element may comprise crease lines and scoring lines to enable folding, in particular to form a container.

Throughout at least some parts of the production system, or throughout the entire production system, the packaging elements may be designated regions in the packaging material. Throughout at least some parts of the production system, or throughout the entire production system, the packaging elements may be blanks cut from the packaging material, or blanks of packaging material.

The packaging element may be configured to form containers for aerosol-generating articles. The packaging element may be configured to be folded into containers for aerosol-generating articles. The containers may be packs, cartons or shipping cases for aerosol-generating articles. The containers may be box-shaped. The identifier markings may be positioned on the packaging elements so as not to be visible on the outside of the container after folding of the packaging element.

The aerosol-generating articles may be rod-shaped. The aerosol-generating articles may be configured to emit aerosol upon heating an aerosol-generating section of the aerosol-generating article. The aerosol-generating articles may comprise a combustible or aerosol-generating section configured to release aerosol when burning. The aerosol-generating article may be configured to be heated to emit aerosol, without burning the aerosol-generating article. The aerosol-generating articles may have a length between 3 centimeters and 15 centimeters, or between 3 centimeters and 10 centimeters, or between 5 centimeters and 8 centimeters.

The identifier markings may be machine readable. The identifier markings may be configured as QR code, or as barcode, or as alphanumeric code, or as number code, for example.

The identifier markings may be unique for each packaging element. The packaging element identification information may be unique for each packaging element.

The printing station may be configured to print onto each of the packaging elements a package decoration element in addition to the identifier marking. The package decoration element and the identifier marking of a packaging element may be printed in a common printing step. The package decoration elements may comprise at least one of: one or more images; one or more text elements; brand information, tactile effects. The package decoration elements may be positioned so as to be visible after the respective packaging element has been folded into a container.

The printing station may comprise a digital printer. The digital printer may be configured to print the identifier markings. The digital printer may be configured to print the package decoration elements. The digital printer may be configured to print an image onto the regions of packaging material that form the packaging elements. The digital printer may be configured to print the image based on digital image information provided to the digital printer. The image may comprise the identifier marking. The image may comprise a package decoration element. The digital printer may allow changing which image is printed by the digital printer by providing digital image data to the digital printer. The digital printer may allow changing which image is printed by the digital printer without changing the physical configuration of the printer, in particular without exchanging a printing plate.

The quality assessment station may be provided downstream of the printing station with respect to the production direction.

The quality assessment station may be configured to read the identifier markings of the packaging elements as the packaging element identification information of the corresponding packaging element. The quality assessment station may be configured to provide the packaging element identification information of one or more of the packaging elements to the controller. The quality assessment station may be configured to provide the result of the quality assessment for one or more of the packaging elements to the controller. The quality assessment station may be configured to provide the packaging element identification information of a packaging element to the controller together with the result of the quality assessment of the packaging element.

The quality assessment of a packaging element may comprise carrying out a measurement on the packaging element. The quality assessment of a packaging element may comprise carrying out a measurement on the package decoration element of the packaging element. The measurement may comprise an optical measurement.

The quality assessment station may comprise an optical quality inspection system. The optical quality inspection system may comprise a camera, such as a CCD camera, for example. The optical quality inspection system may comprise a spectrophotometer.

The quality assessment station may be configured to obtain pictures or videos of the packaging elements. The quality assessment station may be configured to carry out color measurements on the packaging elements, in particular on the package decoration elements of the packaging elements. The quality assessment station may be configured to carry out color measurement on one or more distinct measurement points on each packaging element.

The quality assessment station may be configured to read the identifier markings by analyzing the pictures or videos taken by the quality assessment station.

The quality assessment station may be configured to carry out the quality assessment by analyzing the pictures or the videos. The quality assessment station may be configured to analyze the pictures of videos by means of image processing software or video processing software. The quality assessment station may be configured to both read the identifier markings and carry out the quality assessment by analyzing the same pictures or the same videos.

The quality assessment of a packaging element may comprise evaluating a measurement taken on the packaging element against a quality requirement specification.

The quality assessment of a packaging element may comprise determining a degree to which the packaging element complies with a quality requirement specification. The degree to which the packaging element complies with the quality requirement specification may be determined as a result of the quality assessment of the packaging element. Determining the degree to which the packaging element complies with the quality requirement specification may comprise selecting one of plural predetermined compliance levels. There may be two or more than two predetermined compliance levels. If there are two compliance levels, a first compliance level may be that the packaging element does not sufficiently correspond to the quality requirement specification (quality assessment result: failed), and a second compliance level may be that the packaging element sufficiently corresponds to the quality requirement specification (quality assessment result: passed). If there are more than two compliance levels, a first compliance level may be that the packaging element does not sufficiently correspond to the quality requirement specification, a second compliance level may be that the packaging element corresponds to the quality requirement specification at least to a first degree, but not to a greater third degree, and a third compliance level may be that the packaging element corresponds to the quality requirement specification at least to the third degree.

The quality assessment of a packaging element may comprise determining as a result of the quality assessment whether the packaging element complies with a quality requirement specification.

The quality requirement specification may comprise one or more target values or one or more target ranges. The quality requirement specification may comprise one or more target values and one or more target ranges. The quality requirement specification may comprise different target ranges for the same value, the different target ranges for the same value corresponding to different degrees of compliance with the quality requirement specification.

The quality requirement specification may comprise at least one of: a target color range; a target shape; a target brightness range; a target image; a defect catalogue.

The quality requirement specification may be pre-stored. The quality requirement specification may be determined by user input.

The quality assessment station may be configured to select the quality requirement specification from a set of quality requirement specifications based on the packaging element identification information of a packaging element, when carrying out the quality assessment of the packaging element. By selecting the quality requirement specification based on the packaging element identification information, different kinds of packaging elements may be treated by the quality assessment station without having to manually reconfigure the quality assessment station. The set of quality requirement specifications may be a set of pre-stored quality requirement specifications.

The dataset may comprise the packaging element identification information of only the packaging elements that comply with the quality requirement specification at least to a predetermined degree. The dataset may comprise only the packaging element identification information of the packaging elements that comply with quality requirement specification at least to the predetermined degree. To check whether a specific packaging element was determined to comply with the quality requirement specification at least to the predetermined degree, it may be checked whether the packaging element identification information of the packaging element is comprised in the dataset. If the packaging element identification information of the packaging element is comprised in the dataset, this may indicate that the packaging element was determined to comply with the quality requirement specification at least to the predetermined degree.

The dataset may comprise the packaging element identification information of only the packaging elements that do not comply with the quality requirement specification at least to a predetermined degree. The dataset may comprise only the packaging element identification information of the packaging elements that do not comply with quality requirement specification at least to the predetermined degree. To check whether a specific packaging element was determined to comply with the quality requirement specification at least to the predetermined degree, it may be checked whether the packaging element identification information of the packaging element is comprised in the dataset. If the packaging element identification information of the packaging element is not comprised in the dataset, this may indicate that the packaging element was determined to comply with the quality requirement specification at least to the predetermined degree.

The dataset may comprise datapairs comprising the packaging element identification information of a packaging element and the information whether or to which degree the corresponding packaging element complies with the quality requirement specification. The dataset may comprise the datapairs for each of the packaging elements.

The production system may further comprise a severing station. The severing station may be configured to sever the one or more packaging elements from a remainder of the packaging material. After being severed from the remainder of the packaging material, the packaging element may form a blank of packaging material.

The severing station may be downstream of the quality assessment station with respect to the production direction.

The severing station may be upstream of the quality assessment station with respect to the production direction.

The severing station may be downstream of the printing station with respect to the production direction.

The production system may comprise a sorting station. The sorting station may be provided downstream of the printing station and the quality assessment station with respect to the production direction. The sorting station may be provided downstream of the severing station with respect to the production direction. The sorting station may be configured to read the identifier marking of at least one packaging element, thereby obtaining the packaging element identification information of the at least one packaging element. The sorting station may be configured to retrieve the result of the quality assessment for the at least one packaging element from the stored dataset based on the obtained packaging element identification information.

The sorting station may be configured to deviate the at least one packaging element from a production path based on the retrieved result of the quality assessment. The sorting station may be configured to deviate the at least one packaging element from the production path if the retrieved result of the quality assessment is that the at least one packaging element does not comply with the quality requirement specification, or does not comply with the quality requirement specification at least to a predetermined degree.

The sorting station may comprise a quality marking unit. The quality marking unit may be configured to quality mark the at least one packaging element based on the retrieved result of the quality assessment. Quality marking the at least one packaging element may comprise fail marking the at least one packaging element. For example, the quality marking unit may be configured to quality mark the at least one packaging element if the retrieved result of the quality assessment is that the at least one packaging element does not comply with the quality requirement specification, or does not comply with the quality requirement specification at least to a predetermined degree.

Quality marking the at least one packaging element may comprise rendering the identifier marking of the at least one packaging element unreadable. Quality marking the at least one packaging element may comprise destroying the identifier marking of the at least one packaging element.

Quality marking the at least one packaging element may comprise punching through the at least one packaging element, in particular through the identifier marking of the at least one packaging element. Quality marking the at least one packaging element may comprise printing over the identifier marking of the at least one packaging element. Quality marking the at least one packaging element may comprise burning the identifier marking of the at least one packaging element, for example with a laser.

The production system may comprise a feeding station. The feeding station may be configured to supply the packaging material upstream of one or both of the printing station and the quality assessment station.

The feeding station may be configured to supply the packaging material in the form of a web comprising a plurality of regions forming packaging elements. The feeding station may be configured to supply the packaging material from a supply bobbin. The feeding station may be configured to receive the supply bobbin. The web may comprise at least 100, or at least 250, or at least 500, or at least 1000, or at least 5000 regions forming packaging elements. The web may comprise less than 100000, or less than 50000, or less than 35000, or less than 10000, or less than 5000, or less than 2000, or less than 1000 regions forming packaging elements.

The feeding station may be configured to supply the packaging material in the form of sheets. Each sheet may comprise exactly one region that forms a packaging element. Each sheet may comprise more than one region that forms a packaging element. Each sheet may comprise at least one, or at least two, or at least four, or at least six, or at least eight, or at least ten regions that form packaging elements. Each sheet may comprise less than 1000, or less than 100, or less than 50, or less than 25, or less than eleven, or less than seven, or less than five regions that form packaging elements.

The feeding station may comprise a hopper receiving the sheets.

The packaging material may be in the form of sheets. The packaging material may be provided to the printing station in the form of sheets. The transport system may be configured to provide the packaging material to the printing station in the form of sheets. The packaging material may be provided to the quality assessment station in the form of sheets. The transport system may be configured to provide the packaging material to the quality assessment station in the form of sheets. The packaging material may be provided to the severing station in the form of sheets. The transport system may be configured to provide the packaging material to the severing station in the form of sheets. The severing station may be configured to sever the one or more packaging elements from the sheets. Each sheet may comprise one or more regions that form packaging elements. Each sheet may comprise one or several regions that form packaging elements or a multitude of regions that form packaging elements. Each sheet may comprise at least one, or at least two, or at least four, or at least six, or at least eight, or at least ten packaging elements. Each sheet may comprise less than 1000, or less than 100, or less than 50, or less than 25, or less than eleven, or less than seven, or less than five packaging elements.

The packaging material may be in the form of a web. The packaging material may be provided to the printing station in the form of a web. The transport system may be configured to provide the packaging material to the printing station in the form of a web. The packaging material may be provided to the quality assessment station in the form of a web. The transport system may be configured to provide the packaging material to the quality assessment station in the form of a web. The severing station may be configured to sever the packaging elements from the web. The web may comprise a plurality of regions that form packaging elements. The web may comprise at least 100, or at least 250, or at least 500, or at least 1000, or at least 5000 packaging elements. The web may comprise less than 100000, or less than 50000, or less than 35000, or less than 10000, or less than 5000, or less than 2000, or less than 1000 packaging elements.

The production system may comprise a batch collection station. The batch collection station may be configured to collect the packaging material comprising a batch of packaging elements downstream of at least the printing station and the quality assessment station. The batch collection station may be configured to collect the packaging material with the packaging elements integral to the packaging material.

The batch collection station may comprise a sheet receiving unit configured to stack the packaging material in the form of sheets comprising multiple packaging elements per sheet.

The batch collection station may comprise a winding unit configured to wind up the packaging material in the form of a web comprising a batch of packaging elements. The winding unit may be configured to wind up the packaging material onto a bobbin.

The production system may further comprise a batch marking device. The batch marking device may be configured to generate a batch marker that is readable as unique batch identification information of a specific batch of packaging elements. The batch marker may be applied to the packaging material comprising the respective batch of packaging elements. The unique batch identification information may be linked to the dataset stored in the data memory for the respective batch of packaging elements. The unique batch identification information may allow retrieving the dataset stored in the data memory for the respective batch of packaging elements. The batch marker may be a stack marker corresponding to a stack of sheets collected by the batch collection station. The batch marker may be a bobbin marker corresponding to a bobbin of web wound-up by the batch collection station.

The packaging material comprising the batch of packaging elements from the batch collection station may be subjected to additional treatment steps. The additional treatment steps may be carried out at a different production system. The different production system may, for example, be in a different room or in a different production facility. The additional production steps may use the dataset from the data memory. The additional production steps may comprise retrieving the dataset corresponding to the batch of packaging elements bases on the unique batch identification information obtained from the batch marker. The dataset may be transferred to a different data memory or may be accessible via a cloud system, for example. In the additional production steps, the results of the quality assessment may be retrieved based on the identifier markings of the packaging elements and based on the dataset.

The additional production steps may comprise severing the packaging elements from a remainder of the packaging material, in particular at a severing station. The additional production steps may comprise deviating one or more packaging element from a production path based on the result of the quality assessment of the one or more packaging element as retrieved based on the dataset, in particular by a sorting station.

According to another aspect of the present invention, there is provided a method for quality control of packaging elements for consumer products. Each of multiple packaging elements for consumer products are marked with an identifier marking. The identifier marking is readable as packaging element identification information of the packaging element. A quality assessment of each of the multiple packaging elements is carried out. A dataset is stored. The dataset allows retrieving a result of the quality assessment for any one of the multiple packaging elements based on the product identification information of the particular packaging element.

The quality assessment of a packaging element may comprise determining as a result of the quality assessment a degree to which the packaging element complies with a quality requirement specification. The quality assessment of a packaging element may comprise determining as a result of the quality assessment whether the packaging element complies with the quality requirement specification.

The quality assessment of a packaging element may comprise carrying out a measurement on the packaging element. The quality assessment for a packaging element may comprise evaluating the measurement against the quality requirement specification.

The dataset may comprise the packaging element identification information of only the packaging elements that comply with the quality requirement specification at least to a predetermined degree. The dataset may comprise the packaging element identification information of only the packaging elements that comply with the quality requirement specification.

The dataset may comprise the packaging element identification information of only the packaging elements that do not comply with the quality requirement specification at least to a predetermined degree. The dataset may comprise the packaging element identification information of only the packaging elements that do not comply with the quality requirement specification.

The dataset may comprise datapairs comprising the packaging element identification information of a particular packaging element and the information whether or to which degree the packaging element complies with the quality requirement specification.

The method may comprise reading the identifier markings of at least one of the packaging elements, thereby obtaining the packaging element identification information of the at least one packaging element. The method may comprise retrieving the result of the quality assessment for the at least one packaging element from the stored dataset based on the obtained packaging element identification information.

The method may comprise treating the at least one packaging element in a manner depending on the retrieved result of the quality assessment.

The at least one packaging element may be deviated from a production path, depending on the retrieved result of the quality assessment. The at least one packaging element may be deviated from a production path, if the retrieved result of the quality assessment is that the packaging element does not comply with the quality requirement specification at least to a predetermined degree. The at least one packaging element may be deviated from a production path, if the retrieved result of the quality assessment is that the packaging element does not comply with the quality requirement specification.

The at least one packaging element may be quality marked with a quality marking unit based on the retrieved result of the quality assessment. The at least one packaging element may be quality marked with a quality marking unit, if the retrieved result of the quality assessment is that the packaging element does not comply with the quality requirement specification at least to a predetermined degree. The at least one packaging element may be quality marked with a quality marking unit, if the retrieved result of the quality assessment is that the packaging element does not comply with the quality requirement specification.

Marking each of the multiple packaging elements with an identifier marking may comprise printing the identifier marking onto the packaging element. The identifier markings may be printed onto the packaging elements with a digital printer.

The quality assessment may comprise assessing a printing quality of an imprint of the packaging element. The quality assessment may comprise determining whether the printing quality of a print of the packaging element fulfills the quality requirement specification. The quality assessment may comprise determining whether a printing quality of the package decoration element fulfills the quality requirement specification.

The identifier marking and a package decoration element may be printed onto the packaging elements in a same printing step. The identifier marking and the package decoration element may be printed onto the packaging elements by a digital printer. The identifier marking and the package decoration element may be printed onto the packaging element by the same printer, in particular by the same digital printer.

The method may further comprise severing the packaging element from a web of packaging material or from sheets of packaging material.

Marking the packaging element may be carried out before the packaging element is severed from the web of packaging material or from a sheet of packaging material. The quality assessment of the packaging element may be carried out before the packaging element is severed from the web of packaging material or from a sheet of packaging material.

The method may further comprise collecting the packaging material comprising a batch of packaging elements after marking of the packaging elements and carrying out the quality assessment of the packaging elements. The packaging material may be collected with the packaging elements integral to the packaging material.

The packaging material may be collected by being stacked in the form of sheets comprising multiple packaging elements per sheet.

The packaging material may be collected by being wound up in the form of a web comprising a batch of packaging elements. The packaging material may be wound onto a bobbin.

The method may further comprise generating a batch marker that is readable as unique batch identification information of a specific batch of packaging elements. The batch marker may be applied to the packaging material comprising the respective batch of packaging elements. The unique batch identification information may be linked to the dataset stored in the data memory for the respective batch of packaging elements. The unique batch identification information may allow retrieving the dataset stored in the data memory for the respective batch of packaging elements. The batch marker may be a stack marker corresponding to a stack of sheets collected by the batch collection station. The batch marker may be a bobbin marker corresponding to a bobbin of web wound-up by the batch collection station.

The packaging elements may be packaging elements for aerosol-generating articles.

According to another aspect of the present invention, there is provided a use of a readable identifier marking printed on a packaging element for a consumer product to attribute results from a prior quality assessment of the packaging element to the particular packaging element during a production process.

The identifier marking may be read, thereby obtaining packaging element identification information of the packaging element. A result of the quality assessment for the packaging element may be retrieved from a stored dataset based on the obtained packaging element identification information. The packaging element may be deviated from a production path depending on the retrieved result of the quality assessment.

The identifier marking may be printed by a digital printer. The identifier marking may be printed together with a package decoration element.

After the quality assessment of the packaging element, a dataset may be stored. The dataset may allow retrieving a result of the quality assessment based on the product identification information of the packaging element.

The packaging element may be a packaging element for aerosol-generating articles.

As described, the invention provides a production system for packaging elements, a method for quality control of packaging elements, and a use of a readable identifier marking. The production system may be suitable, adapted or configured to carry out the method or the use. The method and the use may be carried out with the production system. Features, examples, and descriptions presented for any one of the production system, the method for quality control, and the use of a readable identifier marking may be transferred to or combined with any other one of the production system, the method for quality control, and the use of a readable identifier marking.

The invention is defined in the claims. However, below there is provided a non-exhaustive list of non-limiting examples. Any one or more of the features of these examples may be combined with any one or more features of another example, embodiment, or aspect described herein.

Example Ex1: Production system for packaging elements for aerosol-generating articles, wherein a packaging element is formed by a region of a packaging material, wherein the production system comprises:
a printing station configured to print onto each of the packaging elements an identifier marking that is readable as packaging element identification information of the corresponding packaging element;
a quality assessment station configured to carry out a quality assessment of each packaging element;
a transport system configured to transport the packaging elements along a production direction at least through the printing station and the quality assessment station; and
a data memory;
wherein the production system comprises a controller configured to store in the data memory a dataset that allows retrieving a result of the quality assessment for any one of the packaging elements based on the packaging element identification information of the particular packaging element.

Example Ex2: Production system according to Example Ex1, wherein the printing station is configured to print onto each of the packaging elements a package decoration element in addition to the identifier marking.

Example Ex3: Production system according to Example Ex1 or Ex2, wherein the printing station comprises a digital printer.

Example Ex4: Production system according to any one of Examples Ex1 to Ex3, wherein the quality assessment station is configured to read the identifier markings of the packaging elements as the packaging element identification information.

Example Ex5: Production system according to any one of Examples Ex1 to Ex 4, wherein the quality assessment of a packaging element comprises carrying out a measurement on the packaging element.

Example Ex6: Production system according to any one of Examples Ex1 to Ex5, wherein the quality assessment station comprises an optical quality inspection system.

Example Ex7: Production system according to any one of Examples Ex1 to Ex6, wherein the quality assessment station is configured to obtain pictures or videos of the packaging elements.

Example Ex8: Production system according to Example Ex7, wherein the quality assessment station is configured to read the identifier markings by analyzing the pictures or the videos.

Example Ex9: Production system according to Example Ex7 or Ex8, wherein the quality assessment station is configured to carry out the quality assessment by analyzing the pictures or the videos.

Example Ex 10: Production system according to any one of Examples Ex1 to Ex 9, wherein the quality assessment comprises determining as a result of the quality assessment a degree to which the packaging element complies with a quality requirement specification.

Example Ex11: Production system according to Example Ex10, wherein the quality requirement specification comprises at least one of the following: a target color range; a target shape; a target brightness range; a target image; a defect catalogue.

Example Ex12: Production system according to Example Ex10 or Ex11, wherein the quality assessment station is configured to select the quality requirement specification from a set of quality requirement specifications based on the packaging element identification information of a packaging element, when carrying out the quality assessment of the packaging element.

Example Ex13: Production system according to any one of Examples Ex10 to Ex12, wherein the dataset comprises the packaging element identification information of only the packaging elements that comply with the quality requirement specification at least to a predetermined degree.

Example Ex14: Production system according to any one of Examples Ex10 to Ex12, wherein the dataset comprises the packaging element identification information of only the packaging elements that do not comply with the quality requirement specification at least to a predetermined degree.

Example Ex15: Production system according to any one of Examples Ex10 to Ex12, wherein the dataset comprises datapairs comprising the packaging element identification information of a packaging element and the information whether or to which degree the packaging element complies with the quality requirement specification.

Example Ex16: Production system according to any one of Examples Ex1 to Ex15, further comprising a feeding station configured to supply the packaging material upstream of one or both of the printing station and the quality assessment station.

Example Ex17: Production system according to Example Ex16, wherein the feeding station is configured to supply the packaging material in the form of a web comprising a plurality of regions forming packaging elements.

Example Ex18: Production system according to any one of Examples Ex1 to Ex17, wherein the transport system is configured to provide the packaging material to the quality assessment station in the form of a web comprising a plurality of regions forming packaging elements.

Example Ex19: Production system according to any one of Examples Ex1 to Ex18, further comprising a severing station configured to sever the packaging elements from a remainder of the packaging material.

Example Ex20: Production system according to Example Ex19, wherein the severing station is downstream of the quality assessment station with respect to the production direction.

Example Ex21: Production system according to Example Ex19, wherein the severing station is upstream of the quality assessment station with respect to the production direction.

Example Ex22: Production system according to any one of Examples Ex1 to Ex21, further comprising a sorting station configured to read the identifier marking of at least one packaging element, thereby obtaining the packaging element identification information of the at least one packaging element, and to retrieve the result of the quality assessment for the at least one packaging element from the stored dataset based on the obtained packaging element identification information.

Example Ex23: Production system according to Example Ex22, wherein the sorting station is configured to deviate the at least one packaging element from a production path based on the retrieved result of the quality assessment.

Example Ex24: Production system according to Example Ex22 or Ex23, wherein the sorting station comprises a quality marking unit configured to quality mark the at least one packaging element based on the retrieved result of the quality assessment.

Example Ex25: Production system according to any one of Examples Ex1 to Ex24, further comprising a batch collection station configured to collect the packaging material comprising a batch of packaging elements downstream of at least the printing station and the quality assessment station.

Example Ex26: Production system according to any one of Examples Ex 1 to Ex25, further comprising a batch marking device configured to generate a batch marker that is readable as unique batch identification information of a specific batch of packaging elements.

Example Ex27: Production system according to Example Ex26, wherein the unique batch identification information is linked to the dataset stored in the data memory for the respective batch of packaging elements.

Example Ex28: Method for quality control of packaging elements for consumer products, the method comprising:
marking each of multiple packaging elements for consumer products with an identifier marking, the identifier marking being readable as packaging element identification information of the packaging element;
carrying out a quality assessment of each of the multiple packaging elements; and storing a dataset that allows retrieving a result of the quality assessment for any one of the multiple packaging elements based on the product identification information of the particular packaging element.

Example Ex29: Method according to Example Ex28, wherein the quality assessment of a packaging element comprises carrying out a measurement on the packaging element.

Example Ex30: Method according to Example Ex28 or Ex29, wherein the quality assessment of a packaging element comprises determining as a result of the quality assessment a degree to which the packaging element complies with a quality requirement specification.

Example Ex31: Method according to Example Ex30, wherein the dataset comprises the packaging element identification information of only the packaging elements that comply with the quality requirement specification at least to a predetermined degree.

Example Ex32: Method according to Example Ex30, wherein the dataset comprises the packaging element identification information of only the packaging elements that do not comply with the quality requirement specification at least to a predetermined degree.

Example Ex33: Method according to Example Ex30, wherein the dataset comprises datapairs comprising the packaging element identification information of a particular packaging element and the information whether or to which degree the packaging element complies with the quality requirement specification.

Example Ex34: Method according to any one of Examples Ex28 to Ex33, further comprising reading the identifier marking of at least one of the packaging elements, thereby obtaining the packaging element identification information of the at least one packaging element, and retrieving the result of the quality assessment for the at least one packaging element from the stored dataset based on the obtained packaging element identification information.

Example Ex35: Method according to Example Ex33, further comprising treating the at least one packaging element in a manner depending on the retrieved result of the quality assessment.

Example Ex36: Method according to Example Ex34 or Ex35, wherein the at least one packaging element is deviated from a production path depending on the retrieved result of the quality assessment.

Example Ex37: Method according to any one of Examples Ex34 to Ex36, wherein the at least one packaging element is quality marked with a quality marking unit depending on the retrieved result of the quality assessment.

Example Ex38: Method according to any one of Examples Ex28 to Ex37, wherein the marking each of the multiple packaging elements with an identifier marking comprises printing the identifier markings onto the packaging elements, in particular with a digital printer.

Example Ex39: Method according to any one of Examples Ex28 to Ex38, wherein the quality assessment comprises assessing a printing quality of a print of the packaging element.

Example Ex40: Method according to any one of Examples Ex28 to Ex39, wherein the identifier marking and a package decoration element are printed onto each packaging element in a same printing step.

Example Ex41: Method according to any one of Examples Ex28 to Ex40, further comprising severing the packaging elements from a web of packaging material or from sheets of packaging material.

Example Ex42: Method according to Example Ex41, wherein at least one of marking of the packaging element and carrying out the quality assessment of the packaging element is carried out before the packaging element is severed from the web of packaging material or from a sheet of packaging material.

Example Ex43: Method according to any one of Examples Ex28 to Ex42, further comprising collecting packaging material comprising a batch of packaging elements after marking of the packaging elements and carrying out the quality assessment of the packaging elements.

Example Ex44: Method according to any one of Examples Ex28 to Ex43, further comprising generating a batch marker that is readable as unique batch identification information, wherein the unique batch identification information is linked to the dataset stored in the data memory.

Example Ex45: Method according to any one of Examples Ex28 to Ex44, wherein the packaging elements are packaging elements for aerosol-generating articles.

Example Ex46: Use of a readable identifier marking printed on a packaging element for a consumer product to attribute results from a prior quality assessment of the packaging element to the particular packaging element during a production process.

Example Ex47: Use according to Example Ex46, wherein the identifier marking is read, thereby obtaining packaging element identification information of the packaging element, wherein a result of the quality assessment for the packaging element is retrieved from a stored dataset based on the obtained packaging element identification information.

Example Ex48: Use according to Example Ex47, wherein the at least one packaging element is deviated from a production path depending on the retrieved result of the quality assessment.

Example Ex49: Use according to any one of Examples Ex46 to Ex 48, wherein the identifier marking is printed by a digital printer together with a package decoration element.

Example Ex50: Use according to any one of Examples Ex46 to Ex49, wherein after the quality assessment of the packaging element, a dataset is stored that allows retrieving a result of the quality assessment based on the product identification information of the packaging element.

Example Ex51: Use according to any one of Examples Ex46 to Ex50, wherein the packaging element is a packaging element for aerosol-generating articles.

Embodiments will now be further described with reference to the figures in which:

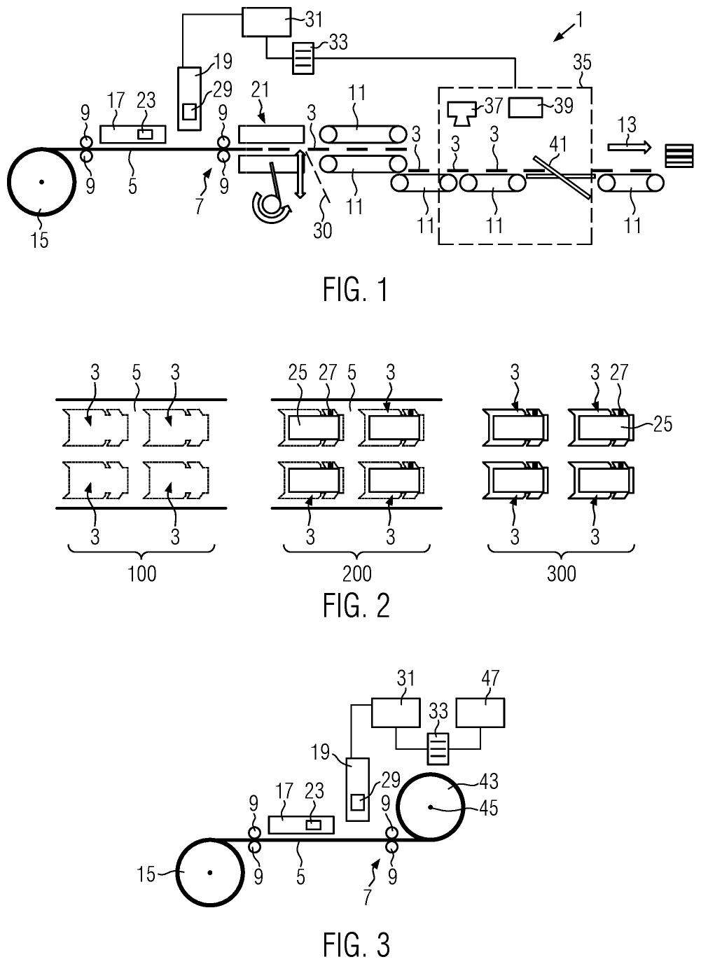

FIG. 1 shows a schematic side view of a production system for packaging elements according to an embodiment using a web as packaging material;

FIG. 2 shows schematic top views onto the web material at different positions in the production system according to the embodiment;

FIG. 3 shows a schematic side view of a production system for packaging elements according to another embodiment using a web as packaging material;

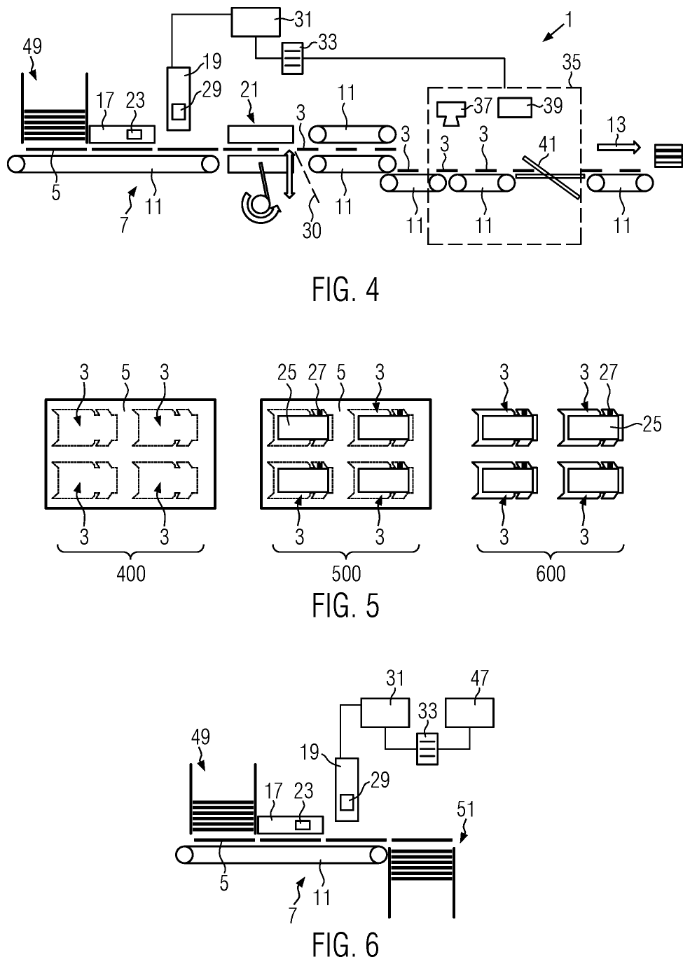

FIG. 4 shows a schematic side view of a production system for packaging elements according to an embodiment using sheets as packaging material;

FIG. 5 shows schematic top views onto the sheet material at different positions in the production system according to the embodiment; and

FIG. 6 shows a schematic side view of a production system for packaging elements according to another embodiment using sheets as packaging material.

FIG. 1 shows a schematic side view of a production system 1 for packaging elements 3 for aerosol-generating articles. In the illustrated embodiment, the packaging elements 3 are configured to be folded into containers for aerosol-generating articles. The packaging elements 3 are formed from packaging material 5 as base material. A transport system 7 comprising transport rollers 9 and conveyors 11 transports the packaging material 5 along a transport direction 13 through the production system 1. In FIG. 1, the transport direction 13 is from left to right. At the upstream end of the production system 1, the packaging material 5 is drawn as a web of packaging material from a supply bobbin 15 provided in a feeding station.

The production system 1 comprises a printing station 17, a quality assessment station 19, and a severing station 21. The severing station 21 is provided downstream of the printing station 17. The quality assessment station 19 is provided between the printing station 17 and the severing station 21.

Part 100 of FIG. 2 shows a top view onto the web of packaging material 5 at a position between the supply bobbin 15 and the printing station 17. The broken lines in part 100 of FIG. 2 indicate regions of the packaging material 5 that form packaging elements 3. The broken lines indicating the regions forming the packaging elements 3 in part 100 of FIG. 2 are only for illustrative purposes and do not indicate any cuts or perforations in the web of packaging material 5.

The printing station 17 comprises a digital printer 23. The digital printer 23 prints a package decoration element 25 and an identifier marking 27 onto each of the regions of the web of packaging material 5 that form the packaging elements 3. The package decoration elements 25 may comprise brand information, user information or decorative elements, for example.

The identifier markings 27 are markings uniquely identifying the individual packaging elements 3. The identifier markings 27 are readable as packaging element identification information of the corresponding packaging element 3. The identifier markings 27 may be printed in the form of a barcode or a QR code, or an alphanumeric code, or a registration number, for example. The package decoration elements 25 may, at least in parts, be the same for each packaging element 3. The identifier markings 27 may be different for each packaging element 3.

Part 200 of FIG. 2 shows a top view onto the web of packaging material 5 at a position between the printing station 17 and the quality assessment station 19, showing the printed package decoration elements 25 and identifier markings 27.

The quality assessment station 19 carries out a quality assessment of each packaging element 3. The quality assessment station 19 comprises an optical quality inspection system 29. The optical quality inspection system 29 may be configured to carry out a quality assessment of the packaging elements 3 based on an optical analysis of the packaging elements 3. In particular, the optical quality inspection system 29 may carry out quality assessment of the printing quality of the package decorations element 27 of the respective packaging element 3. The optical quality inspection system 29 may comprise one or more cameras obtaining pictures or videos of the packaging element 3. The optical quality inspection system 29 may comprise a color measurement device, such as a spectrophotometer, for example. The optical quality inspection system 29 may be configured to carry out a color measurement at one or more positions on each packaging element 3. The quality assessment station 19 is configured to evaluate measurement data from the optical quality inspection system 29 against a quality requirement specification. Based on an evaluation of the measurement data against the quality requirement specification, the quality assessment station 19 determines result of the quality assessment for each packaging element 3.

The quality assessment station 19 is configured to read the identifier markings 27 of the packaging elements 3 as the packaging element identification information. The identifier markings 27 may be read by the optical quality inspection system 29 of the quality assessment station 19, or by an additional detector of the quality assessment station 19. A controller 31 is configured to store a dataset in a data memory 33. The dataset allows retrieving the result of the quality assessment for any one of the packaging elements 3 based on the packaging element identification information of the particular packaging element 3. The controller 31 stores the dataset based on data provided by the quality assessment station 19.

The severing station 21 is configured to sever the packaging elements 3 from the web of packaging material 5, for example by cutting or punching. As schematically shown in FIG. 1, downstream of the severing station 21, the severed packaging elements 3 are transported as individual packaging elements 3 along the transport direction 13. Part 300 of FIG. 2 shows a top view of the packaging elements 3 downstream of the severing station 21. The remainder 30 of the web of packaging material 5, that is the part of the web that was between or around the packaging elements 3, is deviated from the production path at the severing station 21.

Downstream of the severing station 21, a sorting station 35 is provided. The sorting station 35 comprises a reader 37 configured to read the identifier markings 27 of the packaging elements 3 to obtain the packaging element identification information of the packaging elements 3. The reader 37 may comprise an optical reader and a processor for analyzing information from the optical reader. The reader 37 may be configured as a QR code reader, or a barcode reader, or an optical pattern recognition system, or a code reader. The sorting station 35 comprises a sorting station controller 39 that accesses the data memory 33 to obtain the results of the quality assessment of the packaging elements 3 from the dataset based on the packaging element identification information from the reader 37.

The sorting station 35 comprises a sorting device 41 configured to selectively let packaging elements 3 pass along the transport direction 13 or deviate packaging elements 3 from the production path. The sorting device 41 is controlled by the sorting station controller 39 based on the results of the quality assessment retrieved from the dataset to let packaging elements 3, for which the result of the quality assessment is a first result, pass along the transport direction 13 and to deviate packaging elements 3, for which the result of the quality assessment is a second result, from the production path 13.

There may be more than two different results of the quality assessment and corresponding more than two different paths into which the packaging elements 3 are sorted based on the results of the quality assessment. In the illustrated embodiment, the first result of the quality assessment is that the quality assessment was passed. The packaging elements 3 for which the result of the quality assessment was the first result are transported along the transport direction 13 downstream of the sorting station 35 to be stacked and subjected to further production steps. In the illustrated embodiment, the second result of the quality assessment is that the quality assessment has not been passed. The packaging elements 3 for which the result of the quality assessment was the second result may be deviated by the sorting device 41 into a waste receptacle, for example.

The packaging elements 3 from the stack of packaging elements 3 that passed the quality assessment may be subjected to further steps to be formed into containers for aerosol-generating articles, in particular into packs or shipping containers for aerosol-generating articles.

In the embodiment described with reference to FIGS. 1 and 2, the printing, the quality assessment, the severing, and the sorting was carried out in one production line comprising the printing station 17, the quality assessment station 19, the severing station 21, and the sorting station 35. FIG. 3 shows an alternative embodiment in which the production system 1 comprises the printing station 17, the quality assessment station 19, and the controller 31, but not the severing station 21 and the sorting station 35. The printing station 17 and the quality assessment station 19 may be the same as in the embodiment of FIG. 1. Also, in the same manner as in the embodiment of FIG. 1, the controller 31 stores the dataset in the data memory 33 that allows retrieving the results of the quality assessment for any one of the packaging elements 3 based on the packaging element identification information of the packaging element 3. In the embodiment of FIG. 3, the web of packaging material 5 with the packaging elements 3 of a batch of packaging elements 3 is wound up onto a bobbin 43 by a winding unit 45 downstream of the quality assessment station 19. The wound-up web of packaging material 5 contains the packaging elements 3 with the printed package decoration elements 25 and the printed identifier markings 27.

A batch marking device 47 generates a batch marker that is readable as unique batch identification information. The unique batch identification information is linked to the dataset stored in the data memory 33. The batch marking device 47 may generate the batch marker as a sticker with a code that is readable as the unique batch identification information. The code may be a QR code, or a barcode, or a number code, for example. The sticker may be put on the bobbin 43. The bobbin 43 may be brought to another production system, where the bobbin 43 may be unwound and production may continue. The other production system may, for example, comprise a severing station 21 and a sorting station 35. The other production system may be configured to read the batch marker to obtain the unique batch identification information. Based on the unique batch identification information, the other production system may retrieve the dataset from the data memory 33 to enable retrieving the result of the quality assessment for the packaging elements 3 based on the identifier markings of the packaging elements 3.

FIGS. 4 and 5 show an alternative embodiment, which is similar to the embodiment of FIGS. 1 and 2. In the embodiments of FIGS. 4 and 5, the packaging material 5 is not supplied to the production system 1 as a web of packaging material, but as sheets of packaging material 5. Aside from this, the production system 1 according to the embodiments of FIGS. 4 and 5 essentially corresponds to the production system 1 according to the embodiments of FIGS. 1 and 2.

Part 400 of FIG. 5 shows a top view of a sheet of packaging material 5 at a position between a hopper 49 of a feeding station providing the sheets of packaging material 5 to the transport system 7 and the printing station 17. As shown in broken lines in part 400 of FIG. 5, each sheet of packaging material 5 comprises multiple regions that form packaging elements 3. In the illustrated embodiment, each sheet of packaging material 5 comprises four regions that each form a packaging element 3.

Part 500 of FIG. 5 shows a top view of a sheet of packaging material 5 at a position between the printing station 17 and the quality assessment station 19 showing the package decoration elements 25 and the identifier markings 27 that were printed onto the regions forming the packaging elements 3 in the printing station 17.

Part 600 of FIG. 5 shows a top view of packaging elements 3 downstream of the severing station 21. In the severing station 21, the packaging elements 3 are severed from the remainder 30 of the respective sheet of packaging material 5, for example by cutting or punching.

FIG. 6 shows an embodiment that is essentially in analogy with the embodiment of FIG. 3. In contrast to the embodiment of FIG. 3, the packaging material 5 is provided to the production system 1 of FIG. 6 as sheets of packaging material 5, and not as a web of packaging material 5. Instead of being wound up downstream of the quality assessment station 19, the packaging material 5 is collected in a stack of sheets of packaging material 5 in a stacking unit 51 downstream of the quality assessment station 19 in the embodiment of FIG. 6. In the embodiment of FIG. 6, the batch marker generated by the batch marking device 47 is put on the collected stack of sheets of packaging material 5 comprising the packaging elements 3. The collected stack may be brought to another production system, where the sheets from the collected stack 43 may be fed into a production path. The other production system may, for example, comprise a severing station 21 and a sorting station 35. The other production system may be configured to read the batch marker to obtain the unique batch identification information. Based on the unique batch identification information, the other production system may retrieve the dataset from the data memory 33 to enable retrieving the result of the quality assessment for the packaging elements 3 based on the identifier markings of the packaging elements 3.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. A production system for packaging elements for aerosol-generating articles, wherein a packaging element is formed by a region of a packaging material, the production system comprising:
a printing station configured to print onto each of the packaging elements an identifier marking that is readable as packaging element identification information of the corresponding packaging element;
a quality assessment station configured to carry out a quality assessment of each packaging element;
a transport system configured to transport the packaging elements along a production direction at least through the printing station and the quality assessment station;
a data memory;
a sorting station; and
a controller configured to store in the data memory a dataset that allows retrieving a result of the quality assessment for any one of the packaging elements based on the packaging element identification information of the particular packaging element,
wherein the sorting station is configured to read the identifier marking of at least one packaging element, thereby obtaining the packaging element identification information of the at least one packaging element, and to retrieve the result of the quality assessment for the at least one packaging element from the stored dataset based on the obtained packaging element identification information.

17. The production system according to claim 16, wherein the printing station is further configured to print onto each of the packaging elements a package decoration element in addition to the identifier marking.

18. The production system according to claim 16, wherein the quality assessment comprises determining as a result of the quality assessment a degree to which the packaging element complies with a quality requirement specification.

19. The production system according to claim 18, wherein the quality requirement specification comprises at least one of the following: a target color range, a target shape, a target brightness range, a target image, and a defect catalogue.

20. The production system according to claim 16, further comprising a feeding station configured to supply the packaging material upstream of one or both of the printing station and the quality assessment station.

21. The production system according to claim 20, wherein the feeding station is further configured to supply the packaging material in a form of a web comprising a plurality of regions forming packaging elements.

22. The production system according to claim 16, wherein the transport system is further configured to provide the packaging material to the quality assessment station in a form of a web comprising a plurality of regions forming packaging elements.

23. The production system according to claim 16, further comprising a severing station configured to sever the packaging elements from a remainder of the packaging material.

24. The production system according to claim 16, wherein the sorting station is further configured to deviate the at least one packaging element from a production path based on the retrieved result of the quality assessment.

25. The production system according to claim 16, further comprising a batch marking device configured to generate a batch marker that is readable as unique batch identification information of a specific batch of packaging elements.

26. A method for quality control of packaging elements for consumer products, the method comprising:
marking each of multiple packaging elements for consumer products with an identifier marking, the identifier marking being readable as packaging element identification information of the packaging element;
carrying out a quality assessment of each of the multiple packaging elements;
storing a dataset that allows retrieving a result of the quality assessment for any one of the multiple packaging elements based on the product identification information of the particular packaging element; and
reading the identifier marking of at least one of the packaging elements, thereby obtaining the packaging element identification information of the at least one packaging element, and retrieving the result of the quality assessment for the at least one packaging element from the stored dataset based on the obtained packaging element identification information,
wherein the at least one packaging element is deviated from a production path depending on the retrieved result of the quality assessment.

27. The method according to claim 26, wherein the quality assessment of a packaging element comprises determining as a result of the quality assessment a degree to which the packaging element complies with a quality requirement specification.

28. The method according to claim 26, wherein the identifier marking and a package decoration element are printed onto each packaging element in a same printing step.

29. The method according to claim 26, further comprising severing the packaging elements from a web of packaging material or from sheets of packaging material.

30. A method for quality control of packaging elements for consumer products, the method comprising:
attributing results from a prior quality assessment of a packaging element to a particular packaging element during a production process, by a readable identifier marking printed on the packaging element;
reading the identifier marking, thereby obtaining packaging element identification information of the packaging element;
retrieving a result of the quality assessment for the packaging element, from a stored dataset based on the obtained packaging element identification information; and
deviating the packaging element from a production path depending on the retrieved result of the quality assessment.
